(19) United States
(12) Patent Application Publication
(10) Pub. No.: US 2006/0077862 A1
(43) Pub. Date: Apr. 13, 2006

(54) Objective lens and optical pickup apparatus

(75) Inventors: Kiyono Ikenaka, Tokyo (JP); Kohei Ota, Tokyo (JP); Yuichi Atarashi, Tokyo (JP); Hidekazu Totsuka, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/245,188

(22) Filed: Oct. 7, 2005

(30) Foreign Application Priority Data
Oct. 12, 2004 (JP) JP2004-297698

(51) Int. Cl. G11B 7/00

(52) U.S. Cl. 369/112.23; 369/112.03; 369/112.01

(57) ABSTRACT

An objective lens for an optical pickup apparatus includes: one optical surface in an aspherical shape including a central area for converging the first and second light fluxes having a first area and the second area, and a peripheral area for converging the first light flux. The central area includes a first diffractive structure. The first diffractive structure faces an outer side of the objective lens in the first area and faces an inner side of the objective lens in the second area. The peripheral area is an optical surface which makes a light flux passing through the peripheral area reach to a position apart from the optical axis on an information recording surface of the second optical information recording medium when the optical pickup apparatus records or reproduces information on the second optical information recording medium using the second light flux.

This application is based on Japanese Patent Application No. 2004-297698 filled on Oct. 12, 2004 in Japanese Patent Office, which is hereby incorporated by reference.

### FIELD OF THE INVENTION

The present invention relates to an objective lens opposed to an optical recording medium, and to an optical pickup apparatus provided with this objective lens.

### BACKGROUND OF THE INVENTION

Conventionally, the optical pickup apparatus which reproduces the information recorded in the optical recording medium such as CD or DVD conducts the recording or reproducing of the information when a laser light emitted from a laser light source is converged on the information recording surface of an optical recording medium by an objective lens.

Recently, as such an optical pickup apparatus, there is an apparatus having the compatibility for a plurality of kinds of optical recording media. The objective lens in this optical pickup apparatus respectively converges the laser light of each wavelength emitted from the plurality of laser light sources on the corresponding optical recording medium by being provided with the diffractive structure on the optical surface (for example, refer to Patent Documents 1 and 2).

[Patent Document 1] Tokkai No. 2001-195769

[Patent Document 2] Tokkai No. 2001-216674

However, when the diffractive structure is provided on the optical surface of the objective lens as disclosed in the above Patent Documents 1 and 2, the compatibility can be obtained for a plurality of kinds of optical recording media. There is a possibility that, an edge part of the diffractive structure is not formed as designed because of the limit of the moldability of the lens, the laser light is cut-off by the step part of the diffractive structure, or the diffraction efficiency is lowered because of the error or variation of the using wavelength of the laser light source. They can reduce light amount of the converged spot.

### SUMMARY OF THE INVENTION

An object of the present invention is to provide an objective lens and an optical pickup apparatus having the compatibility for a plurality of kinds of optical recording media, and an ability to increase the light amount in the converged spot.

A structure written in item 1 is an objective lens for an optical pickup apparatus conducting at least one of recording and reproducing information for a first optical information recording medium having a protective layer with a thickness t₁ using a first light flux with a wavelength λ₁, and conducting at least one of recording and reproducing information for a second optical information recording medium having a protective layer with a thickness t₂ (t₂≧t₁) using a second light flux with a wavelength λ₂ (λ₁>λ₂). The objective lens is provided with one optical surface in an aspherical shape including a central area for converging the first light flux and the second light flux and a peripheral area for converging the first light flux. The central area has a first area including the optical axis and the second area surrounding the first area. The central area is provided with a first diffractive structure being a blaze type and including a plurality of ring-shaped zones around an optical axis. The first diffractive structure faces outer side of the objective lens in the first area and faces inner side of the objective lens in the second area. The peripheral area is an optical surface which makes a light flux passing through the peripheral area reach to a position being apart from the optical axis on an information recording surface of the second optical information recording medium when the optical pickup apparatus records or reproduces information on the second optical information recording medium using the second light flux.

Herein, “a direction that the blaze type diffractive structure faces” means a direction that the surface having larger angle to the base aspherical surface faces, in two faces forming each step of the diffractive structure.

According to the structure written in item 1, because the first diffractive structure is provided in the central area, the first light flux can be converged on the information recording surface of the first optical recording medium, and the second light flux can be converged on the information recording surface of the second optical recording medium. Accordingly, the compatibility can be given to a plurality of kinds of optical recording media.

Further, because the direction of the first diffractive structure changes from the outer side to the inner side between the first area and the second area, the optical path difference function of this first diffractive structure has a local maximum value between the first area and the second area.

Each of FIGS. 4(a) to 4(c) is a graph showing an optical path difference function of a objective lens according to the present invention or a conventional objective lens. The vertical axis represents a ratio Φ/λB of an optical path difference function of the first diffractive structure described below and the horizontal axis represents a height from the optical axis. In FIGS. 4(a) and 4(b), the optical path difference function has a local maximum or minimum value between the first area and the second area. It results from a first derivative of the optical path difference function representing the first diffractive structure being 0 in the vicinity of the position where the direction of the diffractive-structure changes. It is necessary that the first derivative of the optical path difference function becomes 0 at least in an area excluding a ring-shaped zone closest to the optical axis and a ring-shaped zone farthest from the optical axis in the central area.

The optical path difference function having a local maximum or minimum value between the first area and the second area, reduces the difference of the maximum value and the minimum value in the central area, compared with the optical path difference function not having a local maximum or minimum value between the first area and the second area as shown in FIG. 4(c). Because each ring-shaped zone is made when the optical path difference function exceeds a product of a blaze wavelength and an integer generally, the number of the ring-shaped zones can be reduced by forming the first diffractive structure such that the optical path difference function has the local minimum or maximum value between the first area and the second area.

Further, the local maximum value becomes a local minimum or maximum value closest to the optical axis because the first area includes the optical axis. Accordingly, as compared to the case where the coefficient C₂ is less than 0, the number of ring-shaped zones can be reduced because the coefficient C₂ of the lowest order of the optical path difference function becomes positive.

Accordingly, when the number of ring-shaped zones is reduced, the light amount in the converged spot can be increased.

Further, the peripheral area makes a light flux passing through the peripheral area reach to a position being apart from the optical axis on an information recording surface of the second optical information recording medium when the optical pickup apparatus records or reproduces information on the second optical information recording medium using the second light flux. Therefore, the diffractive action of the second diffractive structure is smaller than in the case where the second light flux is converged at the position close to the optical axis. Accordingly, the number of ring-shaped zones of the second diffractive structure can be reduced, and the converging performance for the first light flux can be increased.

A structure written in item 11 is an objective lens for an optical pickup apparatus conducting at least one of recording and reproducing information for a first optical information recording medium having a protective layer with a thickness t₁ using a first light flux with a wavelength λ₁, and conducting at least one of recording and reproducing information for a second optical information recording medium having a protective layer with a thickness t₂ (t₂≧t₁) using a second light flux with a wavelength λ₂ (λ₁>λ₂). The objective lens is provided with one optical surface in an aspherical shape including a central area for converging the first light flux and the second light flux and a peripheral area for converging the first light flux. The central area includes a first diffractive structure being a blaze type and including a plurality of ring-shaped zones around an optical axis. An optical path difference function of the first diffractive structure is Φ(h)=C₂h²+ΣC₂ᵢh²ⁱ, where h is a height from an optical axis, i is an integer which is 2 or more, and C₂ and C₂ᵢ are coefficients. The optical path difference function Φ(h) has a local maximum value for a predefined height h₁ which is smallest among heights h corresponding to local minimum or local maximum values of the optical path difference function Φ(h). The peripheral area is an optical surface which makes a light flux passing through the peripheral area reach to a position being apart from the optical axis on an information recording surface of the second optical information recording medium, when the optical pickup apparatus records and reproduces information on the second optical information recording medium using the second light flux.

Herein, the optical path difference function Φ(h) is a function which satisfies Φ(h)>0 when the positive optical path difference is given as compared to the case where there is no first diffractive structure, and satisfies Φ(h)<0 when the negative optical path difference is given as compared to the case where there is no first diffractive structure. This optical path difference function Φ(h) may also further have another local maximum or local minimum value as long as it has a local maximum value in the central area.

According to the structure written in item 11, because the first diffractive structure is provided in the central area, the first light flux can be converged on the information recording surface of the first optical recording medium, and the second light flux can be converged on the information recording surface of the second optical recording medium. Accordingly, the compatibility can be given to a plurality of kinds of optical recording media.

Further, because the optical path difference function Φ(h) shows a local maximum value to the smallest predetermined height among heights h corresponding to each local maximum or local minimum value, this local maximum value becomes the local maximum or minimum value closest to the optical axis. Accordingly, the coefficient C₂ of the lowest order of the optical path difference function becomes positive, and because the total sum of the coefficient C₂ᵢ higher than 2^{nd} order becomes negative, the number of ring-shaped zones can be reduced as compared to the case where the coefficient C₂ is less than 0.

Further, the number of ring-shaped zones can be reduced as compared to the case where it does not have the local minimum or maximum value because the optical path difference function has a local maximum value. Accordingly, the number of ring-shaped zones of the second diffractive structure can be reduced, and the converging performance for the first light flux can be increased.

Further, the peripheral area makes a light flux passing through the peripheral area reach to a position being apart from the optical axis on an information recording surface of the second optical information recording medium when the optical pickup apparatus records or reproduces information on the second optical information recording medium using the second light flux. Therefore, the diffractive action of the second diffractive structure is smaller than in the case where the second light flux is converged at the position close to the optical axis. Accordingly, the number of ring-shaped zones of the second diffractive structure can be reduced, and the converging performance for the first light flux can be increased.

A structure written in Item 21 is an objective lens for an optical pickup apparatus conducting at least one of recording and reproducing information for a first optical information recording medium having a protective layer with a thickness t₁ using a first light flux with a wavelength λ₁, and conducting at least one of recording and reproducing information for a second optical information recording medium having a protective layer with a thickness t₂ (t₂≧t₁) using a second light flux with a wavelength λ₂ (λ₁>λ₂). The objective lens is provided with: one optical surface in an aspherical shape including a central area for converging the first light flux and the second light flux and a peripheral area for converging the first light flux. The central area comprises a first diffractive structure being a blaze type and including a plurality of ring-shaped zones around an optical axis. An optical path difference function of the first diffractive structure is Φ(h)=C₂h²+ΣC₂ᵢh²ⁱ, where h is a height from an optical axis, i is an integer which is 2 or more, and C₂ and C₂ᵢ are coefficients. The coefficients C₂ and C₂ᵢ satisfy the following expression (3).
−ΣC₂ᵢh_{c}²⁽ⁱ⁻¹⁾−10 λ₂ h⁻²≦C₂≦−ΣC₂ᵢh_{c}²⁽ⁱ⁻¹⁾+9 λ₂ h⁻² (3)

Where h_{c} is a height of a boundary between the central area and the peripheral area. The peripheral area is an optical surface which makes a light flux passing through the peripheral area reach to a position being apart from the optical axis on an information recording surface of the second optical information recording medium, when the optical pickup apparatus records and reproduces information on the second optical information recording medium using the second light flux.

According to the structure written in item 21, because the first diffractive structure is provided in the central area, the first light flux can be converged on the information recording surface of the first optical recording medium, and the second light flux can be converged on the information recording surface of the second optical recording medium. Accordingly, the compatibility can be given to a plurality of kinds of optical recording media.

Further, because coefficients C₂ and C₂ᵢ satisfy the above expression (3), the optical path difference function Φ(h) has a local maximum value and this maximum value becomes the local maximum or minimum value closest to the optical axis. Accordingly, the number of the ring-shaped zones can be reduced as compared to the case where the coefficient C2 is less than 0 because the coefficient C₂ of the lowest order of the optical path difference function is positive, and the total sum of the coefficient C₂ᵢ higher than 2nd-order is negative. Further, because the optical path difference-function has the maximum value, the number of the ring-shaped zones can be reduced as compared to the case where it does not have the extreme value.

Accordingly, when the number of ring-shaped zones is reduced, the light amount in the converged spot can be increased.

Further, because the peripheral area makes a light flux passing through the peripheral area reach to a position being apart from the optical axis on an information recording surface of the second optical information recording medium when the optical pickup apparatus records or reproduces information on the second optical information recording medium using the second light flux. Therefore, the diffractive action of the second diffractive structure is smaller than in the case where the second light flux is converged at the position close to the optical axis. Accordingly, the number of ring-shaped zones of the second diffractive structure can be reduced, and the converging performance for the first light flux can be increased.

### BRIEF DESCRIPTION OF THE DRAWINGS

Embodiments will now be described, by way of example only, with reference to the accompanying drawings which are meant to be exemplary, not limiting, and wherein like elements numbered alike in several Figures, in which:

FIG. 1 is a view showing a schematic structure of the optical pickup apparatus according to the present invention;

FIG. 2 is a view showing an objective lens according to the present invention;

Each of FIGS. 3(a) and 3(b) is a view showing an objective lens according to the present invention;

Each of FIGS. 4(a)-4(c) is a view showing a graph of an optical path difference function; and

FIG. 5 is a view showing the relationship between the change amount of the wavelength and the chromatic aberration.

### DETAILED DESCRIPTION OF THE INVENTION

The preferred embodiments are described below.

The structure written item 2 is represented by the structure according to the objective lens of item 1, wherein the objective lens satisfies 1/30>m₁≧0.9×m₂, where m₁ is a magnification of the objective lens for the first light flux, and m₂ is a magnification of the objective lens for the second light flux. The objective lens also satisfies the following expression (2):
0.35 NA_{c}≦NA_{P1}≦0.95 NA_{c},

where NA_{P1} is a numerical aperture of the objective lens for the first light flux passing through only the first area, and NA_{c} is a numerical aperture of the objective lens for the second light flux passing through only the central area.

The direction of the first diffractive structure changes between the first area and the second area and the optical path difference function has a local maximum value. Further, it is necessary that the optical path difference function has a local maximum value at least in an area excluding the ring-shaped zone RS closest to the optical axis and the ring-shaped zone RL farthest from the optical axis in the central area. Herein the numerical aperture NA_{P1} is defined as expression (1), by considering a ring-shaped zone width (pitch) of RS is larger than that of RL and the optical path difference function has the local maximum value on a position corresponding to the ring-shaped zone width.

According to the structure written in item 2, the number of ring-shaped zones can be reduced as compared to the conventional one while the chromatic aberration amount is set to an appropriate value, because the numerical aperture NA_{P1} to the first light flux passing only the first area satisfies the expression (1).

Accordingly, the number of ring-shaped zones of the second diffractive structure can be reduced, and the converging performance for the first light flux can be increased.

Further, because the magnifications m₁ and m₂ satisfy m₁≧0.9×m₂, when m₁>m₂, the divergent angle of the second light flux is larger than the divergent angle of the first light flux. Accordingly, a part of the spherical aberration due to the difference between using wavelengths of a plurality of kinds of the optical recording media or the protective substrate thickness is corrected by the difference of the divergent angle. Therefore, the number of ring-shaped zones can be reduced by an amount in which the diffractive action necessary for the compatibility is reduced. Accordingly, when the number of ring-shaped zones is reduced, the light amount in the converged spot can be increased.

Further, because the magnification m₁ satisfies 1/30>m₁, as compared to the case where 1/30≦m₁, an amount of the coma generated when the optical pickup apparatus moves the objective lens for the tracking can be reduced.

The structure written in item 3 is represented by a structure according to the objective lens of item 1 or 2, wherein the central area is divided into two areas of the first area and the second area.

The structure written in item 3 provides similar effect to that of the structure of item 1 or 2.

The structure written in item 4 is represented by a structure according to the objective lens of any one of items 1 to 3, wherein the peripheral area comprises a second diffractive structure including a plurality of ring-shaped zones around the optical axis.

The structure written in item 5 is represented by a structure according to the objective lens written in item 4, wherein an innermost zone of the plurality of ring-shaped zones of the second diffractive structure has a larger pitch than a pitch of an outermost zone of the plurality of ring-shaped zones of the first diffractive structure.

According to the structure written in item 5, because the pitch of the ring-shaped zone of the innermost side in the second diffractive structure is larger than the pitch of the ring-shaped zone of the outermost side in the first diffractive structure, the number of ring-shaped zones of the second diffractive structure is reduced. Accordingly, the light amount of the converged spot formed by the first light flux can be improved.

the structure written in item 6 is represented by a structure according to the objective lens written item 4 or 5, wherein the peripheral area makes the second light flux passing through the peripheral area reach to an inside of an area having a diameter from 30 to 100 μm around the optical axis on an information recording surface of the second optical information recording medium.

According to the structure written in item 6, because the second light flux passing the peripheral area reaches in the area of the diameter 30-100 [μm] around the optical axis of the information recording surface of the second optical recording medium by the peripheral area, the diffractive action of the second diffractive structure is smaller than in the case where the second light flux is converged at the position close to the optical axis. Accordingly, the number of ring-shaped zones of the second diffractive structure can be reduced, and the converging performance to the first light flux can be increased.

The structure written in item 7 is represented by a structure according to the objective lens written in any one of items 1-6, wherein the objective lens satisfies 0.95×m₁≦m₂≦1.05×m₁, where m₁ is a magnification of the objective lens for the first light flux, m₂ is a magnification of the objective lens for the second light flux.

According to the structure written in item 7, because the magnifications m₁ and m₂ become about the same value, the optical path of the first light flux and the optical path of the second light flux can be coincided with each other. Accordingly, because it becomes unnecessary that the beam splitter for putting the first light flux, the second light flux projected from two light sources on the same optical path is used, and that the collimator lens or beam shaper are respectively arranged in each optical path, the optical pickup apparatus can be down-sized by that amount. Further, because the light source unit provided with 2 light sources in a casing, can be used, the optical pickup apparatus can be down-sized as compared to the case where 2 light sources are separately used.

The structure written in item 8 is represented by a structure according the objective lens written in any one of items 1-7, wherein the wavelength λ₁ of the first light flux is in a range from 630 nm to 680 nm, the wavelength λ₂ of the second light flux is in a range from 770 nm to 790 nm, the thickness t₁ of the protective layer of the first optical information recording medium is in a range of 0.55 mm≦t₁≦0.65 mm, and the thickness t₂ of the protective layer of the second optical information recording medium is in a range of 1.2 mm t₁≦t₂≦2.2 t₁ mm.

The structure written in item 8 provides the same effect as the structure written in any one of items 1-7.

The structure written in item 9 according to the objective lens written in any one of items 1-10, is made of plastic.

According to the structure written in item 9, the workability of the diffractive structure is improved as compared to the case where it is made of glass, and the weight of the objective lens can be reduced because the objective lens is made of plastic.

The structure written in item 10 is an optical pickup apparatus provided with: the objective lens written in any one of items 1 to 9, a first light source for emitting the first light flux, and a second light source for emitting the second light flux.

The structure written in item 10 provides the same effect as the structure written in any one of items 1-9.

The structure written in item 12 is represented by a structure according the objective lens written in item 11, wherein the objective lens satisfies 1/30>m₁≧0.9×m₂, where m₁ is a magnification of the objective lens for the first light flux and m₂ is a magnification of the objective lens for the second light flux. The objective lens also satisfies the following expression (2):
0.35 NA_{c}≦NA_{P2}≦0.95 NA_{c} (2)

Where NA_{P2} is a numerical aperture of the objective lens for the first light flux passing through an area from the optical axis to the predefined height h₁, and NA_{c} is a numerical aperture of the objective lens for the second light flux passing through only the central area.

The direction of the first diffractive structure changes between the first area and the second area and the optical path difference function has a local maximum value. Further, it is necessary that the optical path difference function has a local maximum value at least in an area excluding the ring-shaped zone RS closest to the optical axis and the ring-shaped zone RL farthest from the optical axis in the central area. Herein the numerical aperture NA_{P2} is defined as expression (2), by considering a ring-shaped zone width (pitch) of RS is larger than that of RL and the optical path difference function has the local maximum value on a position corresponding to the ring-shaped zone width.

According to the structure written in item 12, the number of ring-shaped zones can be reduced as compared to the conventional one while the chromatic aberration amount is set to an appropriate value, because the numerical aperture NA_{P2} to the first light flux passing from the optical axis to a predetermined height h₁, satisfies the above expression (2).

Accordingly, the number of ring-shaped zones of the second diffractive structure can be reduced, and the converging performance for the first light flux can be increased.

Further, because the magnifications m₁ and m₂ satisfy m₁≧0.9×m₂, when m₁>m₂, the divergent angle of the second light flux is larger than the divergent angle of the first light flux. Accordingly, a part of the spherical aberration due to the difference between using wavelengths of a plurality of kinds of the optical recording media or the protective substrate thickness is corrected by the difference of the divergent angle. Therefore, the number of ring-shaped zones can be reduced by an amount in which the diffractive action necessary for the compatibility is reduced. Accordingly, when the number of ring-shaped zones is reduced, the light amount in the converged spot can be increased.

Further, because the magnification m₁ satisfies 1/30>m₁, as compared to the case where 1/30≦m₁, an amount of the coma generated when the optical pickup apparatus moves the objective lens for the tracking can be reduced.

The structure written in item 13 is represented by a structure according to the objective lens of item 11 or 12, wherein the optical path difference function Φ(h) has only one minimum value or maximum value. According to the structure written in item 13, the same effect as the structure written in item 11 or 12 can be obtained.

The structure written in item 14 is represented by a structure according to the objective lens of any one of items 11 to 13, wherein the peripheral area includes a second diffractive structure including a plurality of ring-shaped zones around the optical axis.

The structure written in item 15 is represented by a structure according to the objective lens of item 14, an innermost zone of the plurality of ring-shaped zones of the second diffractive structure has a larger pitch than a pitch of an outermost zone of the plurality of ring-shaped zones of the first diffractive structure.

According to the structure written in item 15, because the pitch of the ring-shaped zone of the innermost peripheral side in the second diffractive structure is larger than the pitch of the ring-shaped zone of the outermost peripheral side in the first diffractive structure, the number of ring-shaped zones of the second diffractive structure is reduced. Accordingly, the light amount of the converged spot formed by the first light flux can be improved.

The structure written in item 16 is represented by a structure according to the objective lens of item 14 or 15, wherein the peripheral area makes the second light flux passing through the peripheral area reach to an inside of an area having a diameter from 30 to 100 μm around the optical axis on an information recording surface of the second optical information recording medium.

According to the structure written in item 16, because the second light flux passing the peripheral area reaches in the area of the diameter from 30 to 100 μm around the optical axis of the information recording surface of the second optical recording medium by the peripheral area, the diffractive action of the second diffractive structure is smaller than in the case where the second light flux is converged at the position close to the optical axis. Accordingly, the number of ring-shaped zones of the second diffractive structure can be reduced, and the condensing performance to the first light flux can be increased.

The structure written in item 17 is represented by a structure according to the objective lens of any one of items 11-16, the objective lens satisfies 0.95×m₁≦m₂≦1.05×m₁, where m₁ is a magnification of the objective lens for the first light flux, m₂ is a magnification of the objective lens for the second light flux.

According to the structure written in item 17, because the magnifications m₁ and m₂ become about the same value, the optical path of the first light flux and the optical path of the second light flux can be coincided with each other. Accordingly, because it becomes unnecessary that the beam splitter for putting the first light flux, the second light flux projected from two light sources on the same optical path is used, and that the collimator lens or beam shaper are respectively arranged in each optical path, the optical pickup apparatus can be down-sized by that amount. Further, because the light source unit provided with 2 light sources in a casing, can be used, the optical pickup apparatus can be down-sized as compared to the case where 2 light sources are separately used.

The structure written in item 18 is represented by a structure according the objective lens of any one of items 11-17, wherein a wavelength λ₁ of the first light flux is in a range from 630 nm to 680 nm, a wavelength λ₂ of the second light flux is in a range from 770 nm to 790 nm, a thickness t₁ of a protective layer of the first optical information recording medium is in a range of 0.55≦t₁≦0.65 mm, and a thickness t₂ of a protective layer of the second optical information recording medium is in a range of 1.2 t₁≦t₂≦2.2 t₁ mm.

The structure written in item 18 provides the same effect as the structure written in any one of items 11-17.

The structure written in item 19, according to the objective lens written in any one of items 11-18, is made of plastic.

According to the structure written in item 19, the workability of the diffractive structure is improved as compared to the case where it is made of glass, and the weight of the objective lens can be reduced because the objective lens is made of plastic.

The structure written in item 20 is an optical pickup apparatus comprising: the objective lens written in any one of items 11 to 19, a first light source for emitting the first light flux, and a second light source for emitting the second light flux.

The structure written in item 20, provides the same effect as the structure written in any one of items 11-19.

The structure written in item 22, according to in the objective lens written in item 21, wherein the objective lens satisfies 1/30>m₁≧0.9×m₂, where m₁ is a magnification of the objective lens for the first light flux, and m₂ is a magnification of the objective lens for the second light flux.

Further, because the magnifications m₁ and m₂ satisfy m₁≧0.9×m₂, when m₁>m₂, the divergent angle of the second light flux is larger than the divergent angle of the first light flux. Accordingly, a part of the spherical aberration due to the difference between using wavelengths of a plurality of kinds of the optical recording media or the protective substrate thickness is corrected by the difference of the divergent angle. Therefore, the number of ring-shaped zones can be reduced by an amount in which the diffractive action necessary for the compatibility is reduced. Accordingly, when the number of ring-shaped zones is reduced, the light amount in the converged spot can be increased.

Further, because the magnification m₁ satisfies 1/30>m₁, as compared to the case where 1/30≦m₁, an amount of the coma generated when the optical pickup apparatus moves the objective lens for the tracking can be reduced.

The structure written in item 23 is represented by a structure according to in the objective lens of item 21 or 22, wherein the objective lens is formed of a material having an Abbe constant vd for d-line satisfying 50≦vd≦70, and an chromatic aberration amount I (μm/nm) of a converged spot formed by the first light flux passing through the central area satisfies 0.1<I<0.3.

Herein, the chromatic aberration amount means a change amount of the condensing position in the case where the wavelength is changed by +1 nm.

Further, when the value of Abbe constant vd of the material to the d-line is determined, the wavelength dependency of the diffraction power of the objective lens is unconditionally determined. Further, when the wavelength dependency of the diffraction power is determined, coefficients C₂ and C₂ᵢ of the optical path difference function are unconditionally determined. Accordingly, when Abbe constant vd and a value of the chromatic aberration I are determined, values of coefficients C₂ and C₂ᵢ are unconditionally determined.

According to the structure written in item 23, the first light flux can be converged on the information recording surface of the first optical recording medium, and second light flux can be converged on the information recording surface of the second optical recording medium because the first diffractive structure is provided in the central area. Accordingly, the compatibility can be given to a plurality of kinds of optical recording media.

Further, because Abbe constant vd of the material to d-line is 50≦vd≦70, and the chromatic aberration amount I of the converged spot by the first light flux passing the central area, satisfies 0.1 μm/nm<I<0.3 μm/nm, coefficients C₂ and C₂ᵢ of the optical path difference function are determined as the above expression (3). Hereby, the optical path difference function Φ(h) has a local maximum value, and this local maximum value is the local maximum or minimum value closest to the optical axis. Accordingly, because the coefficient C₂ of the lowest order of the optical path difference function becomes positive, and the total sum of coefficients C₂ᵢ higher than 2nd-order becomes negative, the number of ring-shaped zones can be reduced as compared to the case where it does not have the maximum or minimum value.

The structure written in item 24 is represented by a structure according to the objective lens of any one of items 21 to 23, wherein the peripheral area comprises a second diffractive structure including a plurality of ring-shaped zones around the optical axis.

The structure written in item 25, according to the objective lens written in item 24, wherein an innermost zone of the plurality of ring-shaped zones of the second diffractive structure has a larger pitch than a pitch of an outermost zone of the plurality of ring-shaped zones of the first diffractive structure.

According to the structure written in item 25, because the pitch of the ring-shaped zone of the innermost side in the second diffractive structure is larger than the pitch of the ring-shaped zone of the outermost side in the first diffractive structure, the number of ring-shaped zones of the second diffractive structure is reduced. Accordingly, the light amount of the converged spot formed by the first light flux can be improved.

The structure written in item 26 is represented by a structure according to the objective lens of item 24 or 25, wherein the peripheral area makes the second light flux passing through the peripheral area reach to an inside of an area having a diameter from 30 to 100 μm around the optical axis on an information recording surface of the second optical information recording medium.

According to the structure written in item 26, because the second light flux passing the peripheral area arrives in the area of the diameter from 30 to 100 μm around the optical axis of the information recording surface of the second optical recording medium by the peripheral area, the diffractive action of the second diffractive structure is smaller than in the case where the second light flux is converged at the position close to the optical axis. Accordingly, the number of ring-shaped zones of the second diffractive structure can be reduced, and the condensing performance to the first light flux can be increased.

The structure written in item 27 is represented by a structure according to the objective lens of any one of items. 21-26, the objective lens satisfies 0.95×m₁≦m₂≦1.05×m₁, where m₁ is a magnification of the objective lens for the first light flux, m₂ is a magnification of the objective lens for the second light flux.

According to the structure written in item 27, because the magnifications m₁ and m₂ become about the same value, the optical path of the first light flux and the optical path of the second light flux can be coincided with each other. Accordingly, because it becomes unnecessary that the beam splitter for putting the first light flux, the second light flux projected from two light sources on the same optical path is used, and that the collimator lens or beam shaper are respectively arranged in each optical path, the optical pickup apparatus can be down-sized by that amount. Further, because the light source unit provided with 2 light sources in a casing, can be used, the optical pickup apparatus can be down-sized as compared to the case where 2 light sources are separately used.

The structure written in item 28 is represented by a structure according the objective lens of any one of items 21-27, wherein the wavelength λ₁ of the first light flux is in a range from 630 nm to 680 nm, the wavelength λ₂ of the second light flux is in a range from 770 nm to 790 nm, the thickness t₁ of the protective layer of the first optical information recording medium is in a range of 0.55 mm≦t₁≦0.65 mm, and the thickness t₂ of the protective layer of the second optical information recording medium is in a range of 1.2 t₁ mm≦t₂≦2.2 t₁ mm.

The structure written in item 28 provides the same effect as the structure written in any one of items 21-27.

The structure written in item 29, according to in the objective lens written in any one of items 21-28, is made of plastic.

According to the structure written in item 29, the workability of the diffractive structure is improved as compared to the case where it is made of glass, and the weight of the objective lens can be reduced because the objective lens is made of plastic.

The structure written in item 30 is an optical pickup apparatus comprising: the objective lens written in any one of items 21 to 29, a first light source for emitting the first light flux, and a second light source for emitting the second light flux.

The structure written in item 30, provides the same effect as the structure written in any one of items 21-29.

According to the structure written in items 1, 2, 11, 12, 21, 22, 23, the compatibility can be given to a plurality of kinds of optical recording media, and the light amount in the converged spot can be improved. According to the structure written in items 3 and 13, the same effect as the structure written in items 1 or 11 can be obtained.

According to the structure written in items 5, 15, 25, the same effect as the structure written in any one of items 1 to 4, 11 to 14, 21 to 24 can be obtained, and the light amount of the converged spot formed by the first light flux can be improved.

According to the structure written in items 6, 16 and 26, the same effect as the structure written in any one of items 1 to 5, 11 to 15, 21 to 25 can be obtained, and the number of ring-shaped zones of the second diffractive structure can be reduced and the condensing performance to the first light flux can be improved.

According to the structure written in items 7, 17 and 27, the same effect as the structure written in any one of items 1 to 6, 11 to 16, 21 to 26 can be obtained, and the size of the optical pickup apparatus can be reduced. According to the structure written in items 8, 18 and 28, the same effect as the structure written any one of items 1 to 7, 11 to 17, 21 to 27 can be obtained.

According to the structure written in items 9, 19 and 29, the same effect as the structure written in any one of items 1 to 9, 11 to 19, 21 to 29 can be obtained, and the workability of the diffractive structure can be improved, and the weight of the objective lens can be reduced.

According to the structure written in items 10, 20, 30, the same effect as the structure written in any one of items 1-9, 11-19, 21-29 can be obtained.

While the preferred embodiments of the present invention have been described using specific terms, such description is for illustrative purposes only, and it is to be understood that changes and variations may be made without departing from the sprit or scope of the appended claims.

### EXAMPLES

### THE FIRST EMBODIMENT

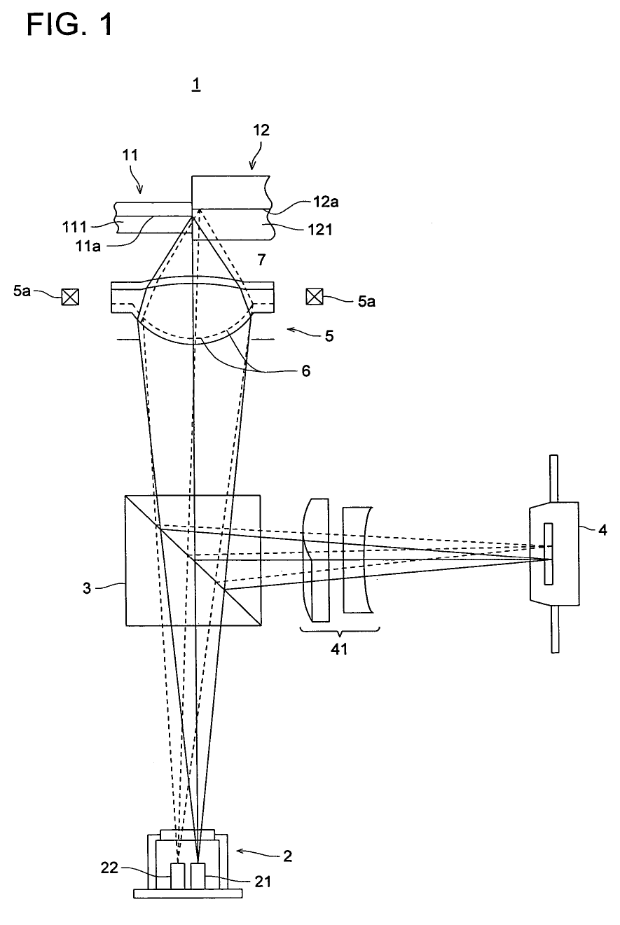

Initially, an embodiment of an optical pickup apparatus according to the present invention will be described below. FIG. 1 is a schematic structural view of an optical pickup apparatus 1. As shown in this view, the optical pickup apparatus 1 has a light source unit 2. Inside the light source unit 2, the first light source 21 and the second light source 22 are arranged.

The first light source 21 emits the first laser light of wavelength 630-680 nm, and in the present embodiment, the wavelength λ₁ of the first laser light is 655 nm. This first laser light is used for the recording of the information for DVD 11 as the first optical recording medium in the present invention, or for the reproducing of the information recorded in DVD 11. Hereupon, the thickness t₁ of the protective layer 111 provided on the information recording surface 11a is 0.55 mm≦t₁≦0.65 mm, and in the present embodiment, 0.6 mm.

The second light source 22 emits the second laser light of wavelength 770 nm-790 nm, and in the present embodiment, the wavelength λ₂ of the second laser light is 785 nm. This second laser light is used for the recording of the information for CD 12 as the second optical recording medium in the present invention, or for the reproducing of the information recorded in CD 12. Hereupon, the thickness t₂ of the protective layer 121 provided on the information recording surface 12a is 1.2 t₁ mm≦t₂≦2.2 t₁ mm, and in the present embodiment, 1.2 mm.

In the front side (upper side in FIG. 1) of the light source unit 2, a beam splitter 3 is arranged. The beam splitter 3 transmits the first laser light, the second laser light in the direction of DVD 11, CD 12, and guides the reflection light from DVD 11, CD 12, that is, returning light to the photo-detector 4.

Sensor lens group 41 is arranged between the beam splitter 3 and the photo-detector 4. This sensor lens group 41 converges the returning light onto the photo-detector 4.

Further, a 2-dimensional actuator 5a is arranged between the beam splitter 3 and CD 12, DVD 11. This 2-dimensional actuator 5a can be moved in a predetermined direction. In the 2-dimensional actuator 5a, the objective lens 5 is mounted.

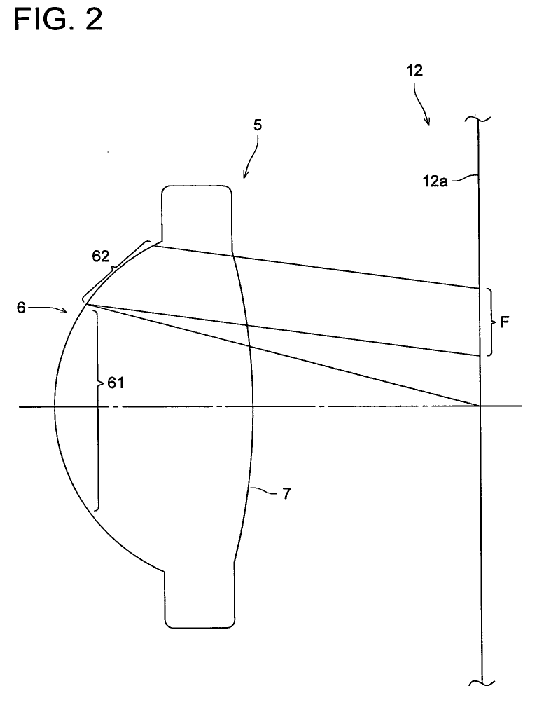

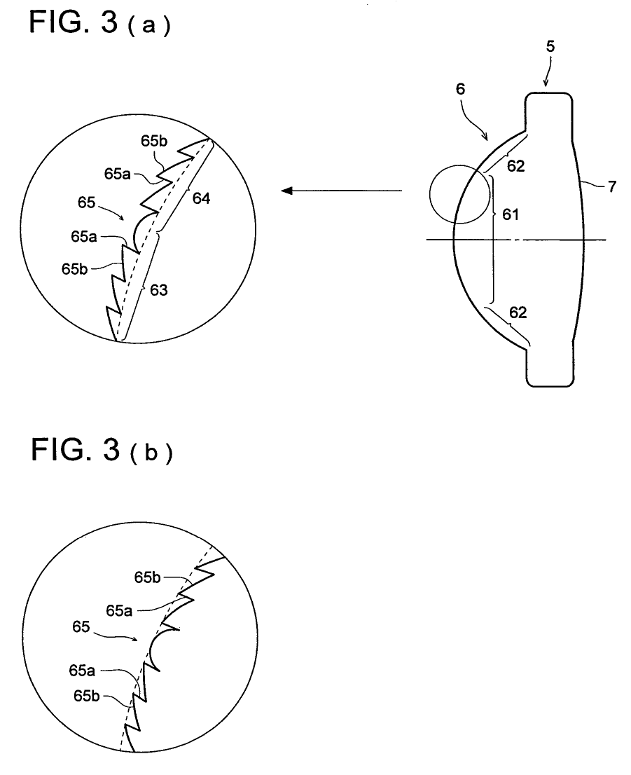

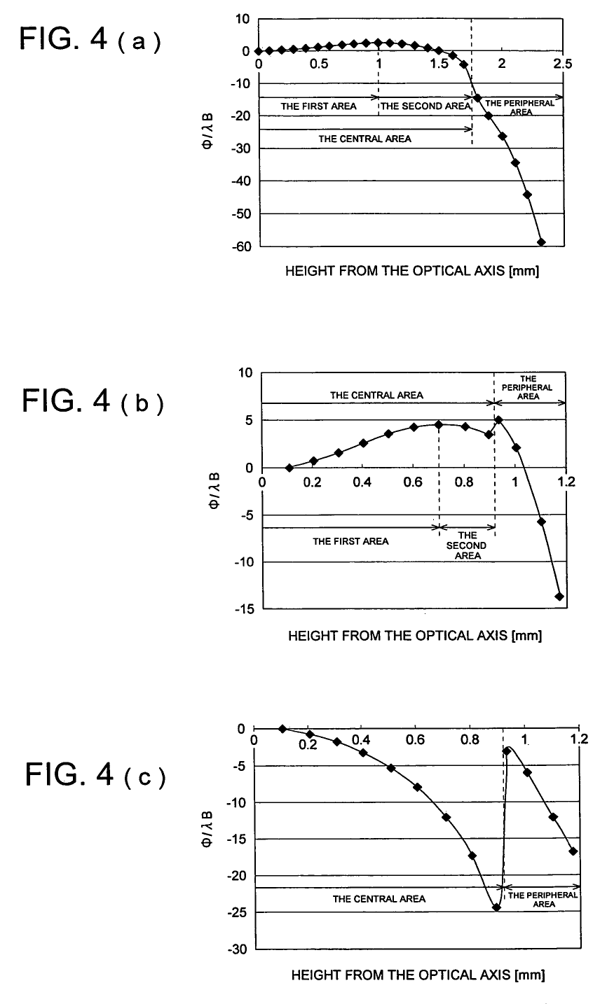

The objective lens 5 has an aspherical surface shaped optical surface 6 and optical surface 7. The optical surface 6 is opposed to the beam splitter 3. This optical surface 6, as shown in FIG. 2, is provided with the central area 61 for condensing the first laser light and the second laser light and the peripheral area 62 for condensing only the first laser light. Hereupon, in FIG. 2, the illustration of the protective layer 121 of CD 12 is neglected.

In the central area 61, as shown in FIG. 3(a), the first diffractive structure 65 is provided in the ring-shaped manner, and the chromatic aberration amount I μm/nm of the converged spot of the first laser light passing the central area 61 is made 0.1<I<0.3.

This first diffractive structure 65 is more protruded outside than the base aspherical surface (refer to the broken line in FIG. 3(a)), and in the first area 63 which is an inner peripheral part of the central area 61, it faces the outermost side, and in the second area 64 which is an peripheral part, faces the innermost side. Hereby, because the optical path difference function φ(h)=C₂h²+ΣC₂ᵢh²ⁱ (where, h is the height from the optical axis, i is an integer larger than 2, C₂, C₂ᵢ are coefficients) of the first diffractive structure 65, shows a local maximum value to a predetermined height hᵢ, and does not show any minimum and maximum values other than this local maximum value, as the result that the coefficient C₂ of the lowest order of the optical path difference function Φ(h) becomes positive, and the total sum of the coefficients C₂ᵢ more than 2nd-order becomes negative, the number of ring-shaped zones is decreased as compared to the case where the coefficient C₂ is less than 0. Further, because the optical path difference function Φ(h) has the a local maximum value, the number of the ring-shaped zones is reduced as compared to the case where it does not have the extreme value.

Hereupon, the direction of the diffractive structure 65 means a direction in which the surface 65a whose angle formed to the base aspherical surface is larger opposes, in two surfaces 65a, 65b composing each ring-shaped zone.

Herein, because the numerical aperture NA_{P1} to the first laser light passing only first area 63 satisfies the following expression (1), the chromatic aberration amount becomes an appropriate value, and the number of ring-shaped zones is more reduced than the conventional one. Hereupon, in the expression (1), “NA_{c}” is the numerical aperture to the second laser light passing only the central area 61.
0.35 NA_{c}≦NA_{P1}≦0.95 NA_{c} (1)

In the same manner, because the numerical aperture NA_{P2} to the first laser light passing from the optical axis to the predetermined height h₁ satisfies the following expression (2), the chromatic aberration amount becomes an appropriate value, and the number of ring-shaped zones is smaller than the conventional one.
0.35 NA_{c}≦NA_{P2}≦0.95 NA_{c} (2)

Further, because the coefficients C₂, C₂ᵢ of the optical path difference function Φ(h) satisfies the following expression (3), the optical path difference function Φ(h) has a local maximum value, and as the result that this maximum value is the local minimum or maximum value closest to the optical axis, as described above, the number of ring-shaped zones is reduced. Hereupon, in the expression (3), “h_{c}” is the height in the border between the central area 61 and the peripheral area 62.
−ΣC₂ᵢh²⁽ⁱ⁻¹⁾−10 λ₂h²≦C₂≦−ΣC₂ᵢh_{c}²⁽ⁱ⁻¹⁾+9 λ₂h⁻² (3)

In the peripheral area 62, the second diffractive structure (not shown) is provided in a plurality of ring-shaped zones manner around the optical axis. The pitch of the ring-shaped zone of the innermost side in this second diffractive structure is larger than the pitch of the ring-shaped zone of the outermost side in the first diffractive structure 65, hereby, the number of ring-shaped zones of the second diffractive structure is reduced.

Further, this second diffractive structure, as shown in FIG. 2, makes the second laser light passing the peripheral area 62 arrive in the area of the diameter 30 μm-100 μm around the optical axis in the information recording surface 12a of CD 12, and forms the flare F. Hereby, by an amount in which the diffractive action of the second diffractive structure is reduced, the number of ring-shaped zones of the second diffractive structure is reduced as compared to the case where the second laser light passing the peripheral area 62 is converged in the position close to the optical axis, and further, the condensing performance to the first laser light is improved.

The optical surface 7 opposes to DVD 11, CD 12. Hereupon, in the above optical surfaces 6, 7, the well known reflection prevention film (not shown) or the protective layer may also be provided.

The objective lens 5 described above, is formed by the injection molding of the plastic material. Therefore, the workability of the first diffractive structure 65, second diffractive structure is good as compared to the case where the objective lens 5 is made of glass, and the weight of the objective lens 5 is reduced.

Further, because Abbe constant vd of the plastic material is 50≦vd≦70, by this range of Abbe constant vd and the range of the above chromatic aberration amount I, coefficients C₂, C₂ᵢ of the optical path difference function are determined as shown in the expression (3). Hereby, as described above, the number of ring-shaped zones of the first diffractive structure 65 is reduced. Hereupon, as the plastic material whose Abbe constant vd is 50≦vd≦70, there is a transparent resin material, such as, for example, PMMA(Abbe constant is 58), or (OPTOREZ OZ1000) (trade name, made by Hitachi Chemical Co., LTD.).

Further, the magnification m₁ to the first laser light of the objective lens 5 and the magnification m₂ to the second laser light satisfy the following expressions (4) and (5). Accordingly, from the relationship of 1/30>m₁, as compared to the case where 1/30≦m₁, the amount of the coma generated when the objective lens 5 is moved for the tracking, is reduced. Further, from the relationship of expression (5), the magnifications m1 and m2 become about the same value, that is, as the result that the divergent angles of the light incident on the objective lens 5 become almost equal, although the compatible action caused when magnifications m1, m2 are different can hardly be obtained, because the optical path of the first laser light and the optical path of the second laser light can be coincided with each other, it is not necessary that the beam splitter for putting the first laser light and the second laser light on the same optical path is used, and it is not necessary that the collimator lens or beam shaper is respectively arranged on each optical path.
1/30>m₁≧0.9×m₂ (4)
0.95×m₁≦m₂≦1.05×m₁ (5)

In succession, the operation of the optical pickup apparatus 1 will be briefly described.

Initially, the first light source 21 and the second light source 22 project the first laser light and the second laser light when the information is recorded in DVD 11, CD12, or when the information in DVD 11, CD 12 is reproduced. After this first laser light and second laser light pass the beam splitter 3, they are converged on the information recording surface 11a and 12a of DVD 11, CD 12 by the objective lens 5, and form the converged spots on the optical axis L.

Herein, because the first diffractive structure 65 is provided in the central area 61, the first laser light is correctly converged on the information recording surface 11a of DVD 11, and the second laser light is correctly converged on the information recording surface 12a of CD 12.

Next, the first laser light, second laser light which form the converged spot, are modulated by the information pit on the information recording surfaces 11a and 12a, and reflected, and reflected by the beam splitter 3 and branched. Then, the branched first laser light, second laser light are incident on the photo-detector 4 via the sensor group 41. The photo-detector 4 detects the spot of the incident light and outputs the signal, and by using the outputted signal, the reading signal of the information recorded on the information recording surfaces 11a, 12a of DVD 11, CD 12 is obtained.

Hereupon, in this case, the light amount change due to shape change or the position change of the spot on the photo-detector 4 is detected, and the focusing detection or tracking detection is conducted. Further, according to this detection result, when the 2-dimensional actuator 5a moves the objective lens 5 in the focus-direction and tracking direction, the converged spot is maintained in the appropriate shape.

According to the optical pickup apparatus 1 as described above, because the first-laser light is correctly converged on the information recording surface 11a of DVD 11, and the second laser light can be correctly converged on the information recording surface 12a of CD 12, the apparatus 1 has the compatibility for DVD 11, CD 12.

Further, because the number of ring-shaped zones can be reduced as compared to the conventional one, the light amount in the converged spot can be improved.

Further, because the number of the beam splitter for putting the first laser light, the second laser light on the same optical path, the collimator lens or beam shaper arranged on the optical path can be reduced, the size of the optical pickup apparatus 1 can be reduced.

Hereupon, in the above embodiment, it is described that the first light source 21, the second light source 22 are arranged inside light source unit 2, however, they may also be arranged at the separate positions. In this case, when the collimator lens is arranged between the first light source 21 and the objective lens 5, the first laser light may also be made the parallel light, and incident on the objective lens 5.

Further, it is described that the first diffractive structure in the present invention is provided on the optical surface 6, however, it may also be provided on the optical surface 7, or on both of optical surface 6 and the optical surface 7.

Further, it is described that magnifications m₁ and m₂ satisfy the above expressions (4) and (5), however, they may also further satisfy m₁>m₂. In this case, because the divergent angle of the second laser light is larger than the divergent angle of the first laser light, as the result that a part of spherical aberration due to the difference between using wavelengths or protective substrate thickness of DVD 11, CD 12 is corrected by the difference of the divergent angle, by the amount in which the diffractive action necessary for the compatibility is reduced, the number of ring-shaped zones can be reduced.

Further, it is described that the first diffractive structure 65 is more protruded outward than the base aspherical surface, however, as shown in FIG. 3(b), it may also be recessed inward.

Next, an example of the objective lens shown in the above embodiment will be described.

### Example 1

The lens data of Example 1 will be shown in Table 1.

TABLE 1

| | | |
|---|---|---|
| Focal length of | f₁ = 3.0 mm | f₂ = 3.03 mm |
| the objective lens | | |
| Numerical aperture | NA1: 0.65 | NA2: 0.51 |
| for image surface side | | |
| Optical system magnification | m1: −1/6.72 | m2: −1/7.04 |
| of the objective lens | | |

| i-th | | di | ni | | ni |
|---|---|---|---|---|---|
| surface | ri | (655 nm) | (655 nm) | di (785 nm) | (785 nm) |
| 0 | | 23.376 | | 23.727 | |
| 1(stop | ∞ | 0.00 | | 0.00 | |
| diameter) | | (φ4.36 mm) | | (φ4.36 mm) | |
| 2 | 1.9840 | 2.50 | 1.529 | 2.50 | 1.525 |
| 2′ | 2.0008 | −0.0006130 | 1.529 | −0.0006130 | 1.525 |
| 3 | −4.1981 | 1.77 | 1.0 | 1.41 | 1.0 |
| 4 | ∞ | 0.6 | 1.578 | 1.2 | 1.571 |
| 5 | ∞ | | | | |

*di expresses the displacement from the i-th surface to the
(i + 1)-th surface.
*di′ expresses the displacement from the i-th surface to the
i′-th surface.

Aspherical surface data and the optical path difference function data
The 2nd surface (0 mm ≦ h ≦ 1.785 mm)
Aspherical surface coefficients

| | |
|---|---|
| κ | −3.5202E−01 |
| A4 | −6.2231E−03 |
| A6 | −1.8153E−03 |
| A8 | 3.1885E−04 |
| A10 | −1.1041E−04 |
| A12 | 2.0484E−05 |
| A14 | −2.6867E−06 |

Optical path difference function
(DVD: 1st-order CD: 1st-order
Blaze wavelength: 690 nm)

| | |
|---|---|
| B2 | 2.9571E−03 |
| B4 | −1.2742E−03 |
| B6 | −3.7926E−05 |

The 2′nd surface (1.785 mm < h)
Aspherical surface coefficients

| | |
|---|---|
| κ | −3.8995E−01 |
| A4 | −5.5026E−03 |
| A6 | −1.8097E−03 |
| A8 | 4.0069E−04 |
| A10 | −1.2848E−04 |
| A12 | 2.3199E−05 |
| A14 | −2.6154E−06 |

Optical path difference function
(DVD: 1st-order CD: 1st-order
Blaze wavelength: 655 nm)

| | |
|---|---|
| B2 | 1.3250E−03 |
| B4 | −1.1895E−03 |
| B6 | −3.7716E−05 |
| B8 | −3.48732E−07 |
| B10 | −1.4676E−06 |

The 3rd surface
Aspherical surface coefficients

| | |
|---|---|
| κ | −2.8712E+01 |
| A4 | −1.0685E−02 |
| A6 | 8.2110E−03 |
| A8 | −2.5921E−03 |
| A10 | 4.9573E−04 |
| A12 | −6.9848E−05 |
| A14 | 5.3367E−06 |

As shown in this table, the objective lens of the present Example 1 is an objective lens for DVD/CD compatible, and set to the focal length f₁=3.0 mm, magnification m₁=−1/6.72 when the wavelength λ₁=655 nm, and set to the focal length f₂=3.03 mm, magnification m₂=−1/7.04 when the wavelength λ₂=785 nm. Hereupon, Abbe constant vd in d-line of the material composing the objective lens is set to 66.1.

Further, the incident surface (the second surface, the 2'nd surface) and the projecting surface (the 3rd surface) of the objective lens are formed into the aspherical surface which is axially symmetrical around the optical axis, specifically, formed into the aspherical surface regulated by the equation in which coefficients in Table 1 are substituted into the following equation. In these surfaces, the second surface and 2'nd surface are optical surfaces in the present invention. Hereupon, the second surface is a central area 61 of the incident surface and the 2nd′ surface is the peripheral area 62.
(Math-1)

$$x ( h ) = \frac{\frac{{h}^{2}}{r}}{1 + \sqrt{1 - ( 1 + κ ) {( \frac{h}{r} )}^{2}}} + {\sum }_{i = 2} {A}_{2 i} {h}^{2 i}$$

Herein, x(h) is the axis in the optical axis direction (the advancing direction of the light is defined as positive), κ is conical coefficient, A₂ᵢ is aspherical surface coefficient, h mm is the height in the direction perpendicular to the optical axis, and r is the radius of curvature.

Further, the first diffractive structure is formed on the second surface, and the second diffractive structure is formed on the 2'nd surface. These first diffractive structure, second diffractive structure are expressed by using the optical-path length added to the transmission wave-front. Such an optical path difference is expressed by the optical path difference function φ which is defined by substituting coefficients shown in Table 1 into the following expression.
φ=Φ(h)×λ×m=(ΣB₂ᵢh²ⁱ)×λ×m (mm)

Where, in this expression, i is an integer larger than 1. Further, B₂ᵢ (=C₂ᵢ×λB) is the coefficient of the optical path difference function, λ nm is the using wavelength, and λB nm is a blaze wavelength. Further, m is the diffraction order of the diffraction light having the maximum diffraction efficiency in the diffraction light of the incident light flux, and in the present Example 1 and Example 2 which will be described later, and the comparative example, m=1.

In the incident surface of the above objective lens, the numerical aperture NA_{P1} is 0.31 and to the numerical aperture NA_{c} (=0.51), satisfies 0.35 NA_{c}≦NA_{P1}≦0.95 NA_{c} in the expression (1).

Further, as shown in FIG. 4(a), the predetermined height h₁ in the incident surface of this objective lens is 1, and the numerical aperture NA_{P2} corresponding to this predetermined height h₁ is 0.31. Accordingly, this numerical aperture NA_{P2} satisfies to the numerical aperture NA_{c}(=0.51), 0.35 NA_{c}≦NA_{P2}≦0.95 NA_{c} in the expression (2).

Further, the coefficients C₂ (=B₂/λB 4.2856×10⁻⁶), C₄ (=−1.8466×10⁻⁶), C₅ (=−5.496×10⁻⁸) of the optical path difference function Φ(h) satisfy the expression (3) to the height h_{c} (1.785).

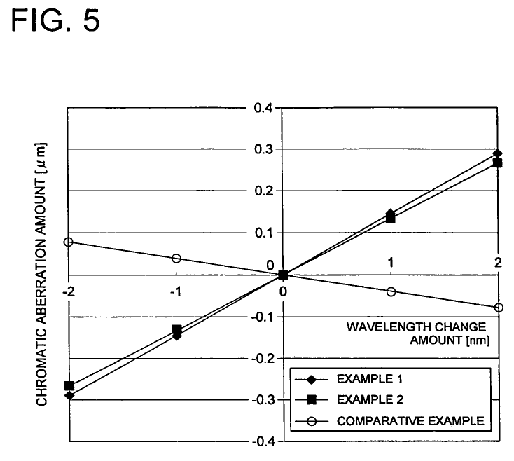

Further, as shown I n FIG. 5, the chromatic aberration amount I of the converged spot formed by the first laser light passing the central area satisfies 0.1 μn/nm<I<0.3 μm/nm.

Further, in this objective lens, when the ring-shaped zone which exists bestriding over the border between the central area 61 and the peripheral area 62, is not counted, the number of ring-shaped zones in the central area 61 is 8, the number of ring-shaped zones in the first area 63 is 2, and the number of ring-shaped zones in the second area is 6.

### Example 2

The lens data of Example 2 will be shown in Table 2.

TABLE 2

| | | |
|---|---|---|
| Focal length of | f₁ = 1.8 mm | f₂ = 1.83 mm |
| the objective lens | | |
| Numerical aperture | NA1: 0.65 | NA2: 0.51 |
| for image surface side | | |
| Optical system magnification | m1: 0 | m2: 0 |
| of the objective lens | | |

| i-th | | di | ni | | ni |
|---|---|---|---|---|---|
| surface | ri | (655 nm) | (655 nm) | di(785 nm) | (785 nm) |
| 0 | | ∞ | | ∞ | |
| 1(stop | ∞ | 0.00 | | 0.00 | |
| diameter) | | (φ2.34 mm) | | (φ2.34 mm) | |
| 2 | 1.0668 | 1.00 | 1.529 | 1.00 | 1.525 |
| 2′ | 1.0762 | −0.002357 | 1.529 | −0.002357 | 1.525 |
| 3 | −3.9999 | 0.87 | 1.0 | 0.52 | 1.0 |
| 3′ | −4.0711 | 0.00 | 1.0 | 0.00 | 1.0 |
| 4 | ∞ | 0.6 | 1.578 | 1.2 | 1.571 |
| 5 | ∞ | | | | |

*di expresses the displacement from the i-th surface to the
(i + 1)-th surface.
*di′ expresses the displacement from the i-th surface to the
i′-th surface.

Aspherical surface data and the optical path difference function data
The 2nd surface (0 mm ≦ h ≦ 0.937 mm)
Aspherical surface coefficients

| | |
|---|---|
| κ | −4.8651E−01 |
| A4 | −1.8608E−02 |
| A6 | −2.2800E−02 |
| A8 | 1.2923E−02 |
| A10 | −1.3852E−02 |
| A12 | 8.7211E−03 |
| A14 | −3.3602E−03 |

Optical path difference function
(DVD: 1st-order CD: 1st-order
Blaze wavelength: 690 nm)

| | |
|---|---|
| B2 | 1.7250E−02 |
| B4 | −1.0818E−02 |
| B6 | −4.9254E−03 |

The 2nd′ surface (0.937 mm < h)
Aspherical surface coefficients

| | |
|---|---|
| κ | −5.0240E−01 |
| A4 | −2.1331E−02 |
| A6 | −2.0998E−02 |
| A8 | 1.7268E−02 |
| A10 | −8.1571E−03 |
| A12 | 7.4362E−03 |
| A14 | −4.4321E−03 |

Optical path difference function
(DVD: 1st-order CD: 1st-order
Blaze wavelength: 655 nm)

| | |
|---|---|
| B2 | 1.3280E−02 |
| B4 | −1.7787E−02 |
| B6 | 6.0911E−03 |

The 3rd surface (0 mm ≦ h ≦ 0.773 mm)
Aspherical surface coefficients

| | |
|---|---|
| κ | −6.9041E+01 |
| A4 | −1.7689E−02 |
| A6 | 8.8165E−02 |
| A8 | −1.0658E−01 |
| A10 | 5.6492E−02 |
| A12 | 1.5335E−02 |
| A14 | −2.7255E−02 |

The 3rd′ surface (0.773 mm < h)
Aspherical surface coefficients

| | |
|---|---|
| κ | −6.5189E+01 |
| A4 | −2.4416E−02 |
| A6 | 8.9348E−02 |
| A8 | −1.0138E−01 |
| A10 | 5.4658E−02 |
| A12 | −1.4738E−02 |
| A14 | 1.3486E−03 |

As shown in this table, the objective lens of the present Example 2 is an objective lens for DVD/CD compatible, and set to the focal length f₁=1.8 mm, magnification m₁=0 when the wavelength λ₁=655 nm, and set to the focal length f₂=1.83 mm, magnification m₂=0 when the wavelength λ₂=785 nm. Hereupon, the first laser light and the second laser light are incident as the parallel light on this objective lens. Further, Abbe constant vd in d-line of the material composing the objective lens is set to 66.1.

On the incident surface (the 2nd surface, 2'nd surface) of this objective lens, the first diffractive structure and the second diffractive structure are formed. Hereupon, the 3rd surface is the central area of the incident surface, and the 3rd′ surface is the peripheral area.

In the incident surface of the objective lens described above, the numeral aperture NA_{P1} is 0.39, and to the numerical aperture NA_{c} (=0.51), satisfies 0.35 NA_{c}≦NA_{P2}≦0.95 NA_{c} in the expression (1).

Further, as shown in FIG. 4(b), in the incident surface of this objective lens, the predetermined height h₁ is 0.7, and the numerical aperture NA_{P2} corresponding to this predetermined height h₁ is 0.39. Accordingly, this numerical aperture NA_{P2} satisfies, to the numerical aperture NA_{c} (=0.51), 0.35 NA_{c}≦NA_{P2}≦0.95 NA_{c} of the expression (2).

Further, coefficients C₂ (=B₂/λB=2.5×10⁻⁵), C₄ (=−1.567×10⁻⁵), C₆ (=−7.1382×10⁻⁶) of the optical path difference function Φ(h) satisfy, to the height h_{c} (0.937), the expression (3).

Further, as shown in FIG. 5, the chromatic aberration I of the converged spot formed by the first laser light passing the central area satisfies 0.1 μm/nm<I<0.3 μm/nm.

Further, in this objective lens, when the ring-shaped zone which exists bestriding over the border between the central area 61 and the peripheral area 62, is not counted, the number of ring-shaped zones in the central area 61 is 5, the number of ring-shaped zones in the first area 63 is 4, and the number of ring-shaped zones in the second area is 1.

### Comparative Example

Lens data of the Comparative Example will be shown in Table 3.

TABLE 3

| | | |
|---|---|---|
| Focal length of | f₁ = 1.8 mm | f₂ = 1.81 mm |
| the objective lens | | |
| Numerical aperture | NA1: 0.65 | NA2: 0.51 |
| for image surface side | | |
| Optical system magnification | m1: 0 | m2: 0 |
| of the objective lens | | |

| i-th | | di | ni | | ni |
|---|---|---|---|---|---|
| surface | ri | (655 nm) | (655 nm) | di(785 nm) | (785 nm) |
| 0 | | ∞ | | ∞ | |
| 1(stop | ∞ | 0.00 | | 0.00 | |
| diameter) | | (φ2.34 mm) | | (φ2.34 mm) | |
| 2 | 1.1417 | 1.00 | 1.529 | 1.00 | 1.525 |
| 2′ | 1.0779 | −0.000948 | 1.529 | −0.000948 | 1.525 |
| 3 | −3.9999 | 0.87 | 1.0 | 0.50 | 1.0 |
| 3′ | −4.0711 | 0.00 | 1.0 | 0.00 | 1.0 |
| 4 | ∞ | 0.6 | 1.578 | 1.2 | 1.571 |
| 5 | ∞ | | | | |

*di expresses the displacement from the i-th surface to the
(i + 1)-th surface.
*di′ expresses the displacement from the i-th surface to the
i′-th surface.

Aspherical surface data and the optical path difference function data
The 2nd surface (0 mm ≦ h ≦ 0.937 mm)
Aspherical surface coefficients

| | |
|---|---|
| κ | −5.2312E−01 |
| A4 | −2.7343E−02 |
| A6 | −1.1777E−02 |
| A8 | 7.1170E−02 |
| A10 | −1.3552E−01 |
| A12 | 8.1334E−02 |
| A14 | −2.2716E−02 |

Optical path difference function
(DVD: 1st-order CD: 1st-order
Blaze wavelength 690: nm)

| | |
|---|---|
| B2 | 0.0000E+00 |
| B4 | −1.2643E−02 |
| B6 | −5.3245E−03 |

The 2nd′ surface (0.937 mm < h)
Aspherical surface coefficients

| | |
|---|---|
| κ | −5.1273E−01 |
| A4 | −2.2595E−02 |
| A6 | −2.1457E−02 |
| A8 | 1.7449E−02 |
| A10 | −9.3652E−03 |
| A12 | 6.2080E−03 |
| A14 | −3.4939E−03 |

Optical path difference function
(DVD: 1st-order CD: 1st-order
Blaze wavelength: 655 nm)

| | |
|---|---|
| B2 | 1.2482E−02 |
| B4 | −1.9577E−02 |
| B6 | 3.3165E−03 |

The 3rd surface (0 mm ≦ h ≦ 0.773 mmQ)
Aspherical surface coefficients

| | |
|---|---|
| κ | −2.3866E+01 |
| A4 | 3.3810E−03 |
| A6 | 1.9602E−01 |
| A8 | −3.8249E−01 |
| A10 | 3.3878E−02 |
| A12 | 3.3531E−01 |
| A14 | −1.8268E−01 |

The 3rd′ surface (0.773 mm < h)
Aspherical surface coefficients

| | |
|---|---|
| κ | −8.7438E+01 |
| A4 | −2.3018E−02 |
| A6 | 8.7500E−02 |
| A8 | −1.0045E−01 |
| A10 | 5.7529E−02 |
| A12 | −1.8379E−02 |
| A14 | 2.5527E−03 |

As shown in this table, the objective lens of the present Comparative Example is an objective lens for DVD/CD compatible, and set to the focal length f₁=1.8 mm, magnification m₁=0 when the wavelength λ₁=655 nm, and set to the focal length f₂=1.81 mm, magnification m₂=0 when the wavelength λ₂=785 nm. Hereupon, the first laser light and the second laser light are incident as the parallel light on this objective lens. Further, Abbe constant vd in d-line of the material composing the objective lens is set to 66.1.

On the incident surface (the 2nd surface, 2'nd surface) of this objective lens, the first diffractive structure and the second diffractive structure are formed.

In the incident surface of the objective lens described above, the direction of the first diffractive structure is only the inner side. Further, as shown in FIG. 4(c), the optical path difference function Φ(h) does not have the extreme value in the central area of this objective lens.

Further, coefficients C₂ (=B₂/λB=0), C₄ (=−1.832×10⁻⁵), C₆ (=−7.716×10⁻⁶) of the optical path difference function Φ(h) do not satisfy, to the height h_{c} (0.937), the expression (3).

Further, as shown in FIG. 5, the chromatic aberration I of the converged spot formed by the first laser light passing the central area does not satisfy 0.1 μm/nm<I<0.3 μm/nm.

Further, in this objective lens, when the ring-shaped zone which exists bestriding over the border between the central area 61 and the peripheral area 62, is not counted, the number of ring-shaped zones in the central area 61 is 24.

What is claimed is:

1. An objective lens for an optical pickup apparatus conducting at least one of recording and reproducing information for a first optical information recording medium having a protective layer with a thickness t₁ using a first light flux with a wavelength λ₁, and conducting at least one of recording and reproducing information for a second optical information recording medium having a protective layer with a thickness t₂ (t₂≧t₁) using a second light flux with a wavelength λ₂ (λ₁>λ₂), the objective lens comprising:
one optical surface in an aspherical shape including
a central area for converging the first light flux and the second light flux, having a first area including an optical axis and the second area surrounding the first area, and
a peripheral area for converging the first light flux,
wherein the central area comprises a first diffractive structure being a blaze type and including a plurality of ring-shaped zones around an optical axis,
the first diffractive structure faces an outer side of the objective lens in the first area and faces an inner side of the objective lens in the second area, and
the peripheral area is an optical surface which makes a light flux passing through the peripheral area reach to a position apart from the optical axis on an information recording surface of the second optical information recording medium when the optical pickup apparatus records or reproduces information on the second optical information recording medium using the second light flux.

2. The objective lens of claim 1,
wherein the objective lens satisfies following expressions:
1/30>m₁≧0.9×m₂
0.35 NA_{c}≦NA_{P1}≦0.95 NA_{c},
where m₁ is a magnification of the objective lens for the first light flux,
m₂ is a magnification of the objective lens for the second light flux,
NA_{P1} is a numerical aperture of the objective lens for the first light flux passing through only the first area, and
NA_{c} is a numerical aperture of the objective lens for the second light flux passing through only the central area.

3. The objective lens of claim 1,
wherein the central area is divided into two areas of the first area and the second area.

4. The objective lens of claim 1,
wherein the peripheral area comprises a second diffractive structure including a plurality of ring-shaped zones around the optical axis.

5. The objective lens of claim 4,
wherein an innermost zone of the plurality of ring-shaped zones of the second diffractive structure has a larger pitch than a pitch of an outermost zone of the plurality of ring-shaped zones of the first diffractive structure.

6. The objective lens of claim 4,
wherein the peripheral area makes the second light flux passing through the peripheral area reach to an inside of an area having a diameter from 30 μm to 100 μm around the optical axis on an information recording surface of the second optical information recording medium.

7. The objective lens of claim 1,
wherein the objective lens satisfies 0.95×m₁≦m₂≦1.05×m₁,
where m₁ is a magnification of the objective lens for the first light flux,
m₂ is a magnification of the objective lens for the second light flux.

8. The objective lens of claim 1,
wherein the wavelength λ₁ of the first light flux is in a range from 630 nm to 680 nm,
the wavelength λ₂ of the second light flux is in a range from 770 nm to 790 nm,
the thickness t₁ of the protective layer of the first optical information recording medium is in a range of 0.55 mm≦t₁≦0.65 mm, and
the thickness t₂ of the protective layer of the second optical information recording medium is in a range of 1.2 t₁ mm≦t₂≦2.2 t₁ mm.

9. The objective lens of claim 1,
wherein the objective lens is made of plastic.

10. An optical pickup apparatus comprising:
the objective lens of claim 1;
a first light source for emitting the first light flux; and
a second light source for emitting the second light flux.

11. An objective lens for an optical pickup apparatus conducting at least one of recording and reproducing information for a first optical information recording medium having a protective layer with a thickness t₁ using a first light flux with a wavelength λ₁, and conducting at least one of recording and reproducing information for a second optical information recording medium having a protective layer with a thickness t₂ (t₂≧t₁) using a second light flux with a wavelength λ₂ (λ₁>λ₂), the objective lens comprising:
one optical surface in an aspherical shape including
a central area for converging the first light flux and the second light flux and
a peripheral area for converging the first light flux,
wherein the central area comprises a first diffractive structure being a blaze type and including a plurality of ring-shaped zones around an optical axis,
an optical path difference function of the first diffractive structure is Φ(h)=C₂h²+ΣC₂ᵢh²ⁱ, where h is a height from an optical axis, i is an integer which is two or more, and C₂ and C₂ᵢ are coefficients,
the optical path difference function Φ(h) has a local maximum value for a predefined height h₁ which is smallest among heights h corresponding to local minimum or local maximum values of the optical path difference function Φ(h), and
the peripheral area is an optical surface which makes a light flux passing through the peripheral area reach to a position apart from the optical axis on an information recording surface of the second optical information recording medium, when the optical pickup apparatus records and reproduces information on the second optical information recording medium using the second light flux.

12. The objective lens of claim 11,
wherein the objective lens satisfies following expressions:
1/30>m₁≧0.9×m₂
0.35 NA_{c}≦NA_{P2}≦0.95 NA_{c}
where m₁ is a magnification of the objective lens for the first light flux,
m₂ is a magnification of the objective lens for the second light flux,
NA_{P2} is a numerical aperture of the objective lens for the first light flux passing through an area from the optical axis to the predefined height h₁, and
NA_{c} is a numerical aperture of the objective lens for the second light flux passing through only the central area.

13. The objective lens of claim 11,
wherein the optical path difference function Φ(h) has only one minimum value or maximum value.

14. The objective lens of claim 11,
wherein the peripheral area comprises a second diffractive structure including a plurality of ring-shaped zones around the optical axis.

15. The objective lens of claim 14,
wherein an innermost zone of the plurality of ring-shaped zones of the second diffractive structure has a larger pitch than a pitch of an outermost zone of the plurality of ring-shaped zones of the first diffractive structure.

16. The objective lens of claim 14,
wherein the peripheral area makes the second light flux passing through the peripheral area reach to an inside of an area having a diameter from 30 μm to 100 μm around the optical axis on an information recording surface of the second optical information recording medium.

17. The objective lens of claim 11,
wherein the objective lens satisfies 0.95×m₁≦m₂≦1.05×m₁,
where m₁ is a magnification of the objective lens for the first light flux,
m₂ is a magnification of the objective lens for the second light flux.

18. The objective lens of claim 11,
wherein the wavelength λ₁ of the first light flux is in a range from 630 nm to 680 nm,
the wavelength λ₂ of the second light flux is in a range from 770 nm to 790 nm,
the thickness t₁ of the protective layer of the first optical information recording medium is in a range of 0.55 mm≦t₁≦0.65 mm, and
the thickness t₂ of the protective layer of the second optical information recording medium is in a range of 1.2 mm t₁≦t₂≦2.2 t₁ mm.

19. The objective lens of claim 11,
wherein the objective lens is made of plastic.

20. An optical pickup apparatus comprising:
the objective lens of claim 11;
a first light source for emitting the first light flux; and
a second light source for emitting the second light flux.

21. An objective lens for an optical pickup apparatus conducting at least one of recording and reproducing information for a first optical information recording medium having a protective layer with a thickness t₁ using a first light flux with a wavelength λ₁, and conducting at least one of recording and reproducing information for a second optical information recording medium having a protective layer with a thickness t₂ (t₂≧t₁) using a second light flux with a wavelength λ₂ (λ₁>λ₂), the objective lens comprising:
one optical surface in an aspherical shape including
a central area for converging the first light flux and the second light flux and
a peripheral area for converging the first light flux,
wherein the central area comprises a first diffractive structure being a blaze type and including a plurality of ring-shaped zones around an optical axis,
an optical path difference function of the first diffractive structure is Φ(h)=C₂h²+ΣC₂ᵢh²ⁱ, where h is a height from an optical axis, i is an integer which is two or more, and C₂ and C₂ᵢ are coefficients, and
the coefficients C₂ and C₂ᵢ satisfy a following expression:
−ΣC₂ᵢh_{c}²⁽ⁱ⁻¹⁾−10 λ₂ h⁻²≦C₂≦−ΣC₂ᵢh_{c}²⁽ⁱ⁻¹⁾+9 λ₂ h⁻²
where h_{c} is a height of a boundary between the central area and the peripheral area, and
the peripheral area is an optical surface which makes a light flux passing through the peripheral area reach to a position apart from the optical axis on an information recording surface of the second optical information recording medium, when the optical pickup apparatus records and reproduces information on the second optical information recording medium using the second light flux.

22. The objective lens of claim 21,
wherein the objective lens satisfies following expressions:
1/30>m₁≧0.9×m₂
where m₁ is a magnification of the objective lens for the first light flux, and
m₂ is a magnification of the objective lens for the second light flux.

23. The objective lens of claim 21,
wherein the objective lens is formed of a material having an Abbe constant vd for d-line satisfying 50≦vd≦70, and
an chromatic aberration amount I μm/nm of a converged spot formed by the first light flux passing through the central area satisfies 0.1<I<0.3.

24. The objective lens of claim 21,
wherein the peripheral area comprises a second diffractive structure including a plurality of ring-shaped zones around the optical axis.

25. The objective lens of claim 24,
wherein an innermost zone of the plurality of ring-shaped zones of the second diffractive structure has a larger pitch than a pitch of an outermost zone of the plurality of ring-shaped zones of the first diffractive structure.

26. The objective lens of claim 24,
wherein the peripheral area makes the second light flux passing through the peripheral area reach to an inside of an area having a diameter from 30 μm to 100 μm around the optical axis on an information recording surface of the second optical information recording medium.

27. The objective lens of claim 21,
wherein the objective lens satisfies 0.95×m₁≦m₂≦1.05×m₁,
where m₁ is a magnification of the objective lens for the first light flux,
m₂ is a magnification of the objective lens for the second light flux.

28. The objective lens of claim 21,
wherein the wavelength λ₁ of the first light flux is in a range from 630 nm to 680 nm,
the wavelength λ₂ of the second light flux is in a range from 770 nm to 790 nm,
the thickness t₁ of the protective layer of the first optical information recording medium is in a range of 0.55 mm≦t₁≦0.65 mm, and
the thickness t₂ of the protective layer of the second optical information recording medium is in a range of 1.2 t₁ mm≦t₂≦2.2 t₁ mm.

29. The objective lens of claim 21,
wherein the objective lens is made of plastic.

30. An optical pickup apparatus comprising:
the objective lens of claim 21,
a first light source for emitting the first light flux, and
a second light source for emitting the second light flux.
